(19) United States
(12) Patent Application Publication
(10) Pub. No.: US 2007/0293284 A1
(43) Pub. Date: Dec. 20, 2007

(54) SLIDING-TYPE ELECTRONIC DEVICE WITH A SEMI-AUTOMATIC OPENING AND CLOSING MECHANISM

(76) Inventor: Chun-Po Chen, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 11/759,950

(22) Filed: Jun. 8, 2007

(30) Foreign Application Priority Data
Jun. 19, 2006 (TW) 095121887

(51) Int. Cl. H04M 1/00

(52) U.S. Cl. 455/575.1

(57) ABSTRACT

An electronic device includes a first module having a rack, and a second module. A slot is positioned on the second module for containing the rack. The second module includes a gear module engaged with the rack in a slidable manner relative to the rack so as to drive the second module to slide relative to the first module.

### BACKGROUND OF THE INVENTION

1. Field of the Invention

The present invention relates to an electronic device, and more particularly, to a sliding-type electronic device with a semi-automatic opening and closing mechanism.

2. Description of the Prior Art

With rapid development of technologies, electronic devices are widely utilized in various fields. For instance, the utilization of a convenient and light mobile phone has become a common way of communication in daily lives. With these mobile devices, people can easily exchange or share information, experiences, and opinions. Mobile phones have progressed tremendously in recent years. Various types of mobile phones are continuously being developed and the demand is still increasing. Together with communication quality, appearance and size-reduction, the ability to provide a user with a more convenient operating environment is also a major concern when designing a mobile phone.

In opening design of the electronic device in the market, part of the opening design of the electronic device utilizes a slide construction, for example, part of the opening design of mobile phones in the market utilize the slide construction, especially in the high-end market segment. Please compare the slide construction mobile phone to that of the straight vertical mobile phone. It is obvious that the size of the slide construction mobile phone is smaller when it is shut and the surface area of keys is wider. Unfortunately, the slide mechanism of the slide construction mobile phone operates predominantly in a manual fashion. If a handset is long and needs a longer opening distance, it appears to be inconvenient for the user. This is especially evident when the user with a small palm wishes to perform the opening function utilizing just one hand, a phenomenon may occur where the phone cannot be not completely open, and this creates inconvenience for the user operating the device.

Please refer to FIG. 1. FIG. 1 is a diagram of a sliding-type mobile phone 10 in the prior art. The sliding-type mobile phone 10 includes a first module 12 and a second module 14. The second module 14 is connected to the top side of the first module 12 in a slidable manner so that a user can close or open the sliding-type mobile phone 10 by pushing the second module 14 towards or away from the first module 12. The first module 12 can include a display panel for displaying images having been processed by the sliding-type mobile phone 10. The second module 14 can include a processing unit for controlling operations of the sliding-type mobile phone 10 and a plurality of keys for inputting control signals to the processing unit. The user can also make a phone call by dialing a telephone number using the keys.

In the prior art sliding-type mobile phone 10, the movement of the first module 12 and the second module 14 is usually controlled by mechanical devices such as springs. The sliding-type mobile phone 10 can be semi-automatically opened and closed based on the inflection point of the springs. In FIG. 1, the first module 12 and the second module 14 of the sliding-type mobile phone 10 are connected using springs 15 and 17 each having two ends respectively connected to the first module 12 and the second module 14. The spring 15 can be curved in response to an external force. In order to close the sliding-type mobile phone 10, a user can apply an external force in a Direction 1 indicated by an arrow in FIG. 1. Once the spring 15 receives sufficient compression and its curvature reaches the inflection point, the inherent elasticity of the spring 15 continues to provide a force in the Direction 1 for closing the sliding-type mobile phone 10. Similarly, in order to open the sliding-type mobile phone 10, a user can apply an external force in a Direction 2 indicated by an arrow in FIG. 1. Once the spring 15 receives sufficient compression and its curvature reaches the inflection point, the inherent elasticity of the spring 15 continues to provide a force in the Direction 2 for opening the sliding-type mobile phone 10. Please refer to FIG. 2. FIG. 2 is a diagram illustrating each stage of the spring 15 while opening/closing the sliding-type mobile phone 10. Stage 1 represents the spring 15 when the sliding-type mobile phone 10 is completely open, Stage 2 represents the spring 15 at its inflection point, and Stage 3 represents the spring 15 when the sliding-type mobile phone 10 is completely closed.

Please refer to FIG. 3. FIG. 3 is a diagram of a sliding-type mobile phone 30 in another prior art. The sliding-type mobile phone 30 also includes a first module 12 and a second module 14. The second module 14 is connected to the top side of the first module 12 in a slidable manner so that a user can close or open the sliding-type mobile phone 30 by pushing the second module 14 towards or away from the first module 12. The first module 12 and the second module 14 of the sliding-type mobile phone 30 are connected using a spring 35 having two ends respectively fixed to the first module 12 and the second module 14. The length of the spring 35 can change in response to an external force. In order to close the sliding-type mobile phone 30, a user can apply an external force in a Direction 1 indicated by an arrow in FIG. 3. Once the spring 35 receives sufficient compression and its length reaches the inflection point, the inherent elasticity of the spring 35 continues to provide a force in the Direction 1 for closing the sliding-type mobile phone 30. Similarly, in order to open the sliding-type mobile phone 30, a user can apply an external force in a Direction 2 indicated by an arrow in FIG. 3. Once the spring 35 receives sufficient compression and its length reaches the inflection point, the inherent elasticity of the spring 35 continues to provide a force in the Direction 2 for opening the sliding-type mobile phone 30. Please refer to FIG. 4. FIG. 4 is a diagram illustrating each stage of the spring 35 while opening/closing the sliding-type mobile phone 30. Stage 1 represents the spring 35 when the sliding-type mobile phone 30 is completely open, Stage 2 represents the spring 35 at its inflection point, and Stage 3 represents the spring 35 when the sliding-type mobile phone 30 is completely closed.

In the prior art sliding-type mobile phones, mechanical devices such as springs are used for controlling the movement of the first module and the second module. The prior art sliding-type mobile phones can be semi-automatically opened or closed using the inherent elasticity of the springs after reaching the inflection point. In such opening mechanism, the interior of the sliding-type mobile phones has to provide large space for disposing the springs, so that the springs can fully operates and provides sufficient stroke for opening and closing the sliding-type mobile phones. Therefore, in the prior art sliding-type mobile phones, large space is required for disposing the springs.

### SUMMARY OF THE INVENTION

It is therefore a primary objective of the claimed invention to provide a sliding-type electronic device with a semi-automatic opening and closing mechanism for solving the above-mentioned problem.

According to the claimed invention, an electronic device includes a first module having a rack, and a second module. A slot is positioned on the second module for containing the rack. The second module includes a gear module engaged with the rack in a slidable manner relative to the rack so as to drive the second module to slide relative to the first module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a sliding-type mobile phone in the prior art.

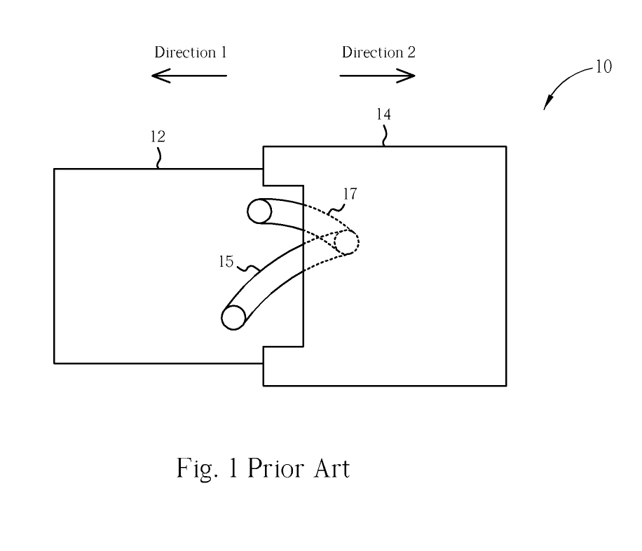

FIG. 2 is a diagram illustrating each stage of a spring while opening/closing the sliding-type mobile phone in FIG. 1.

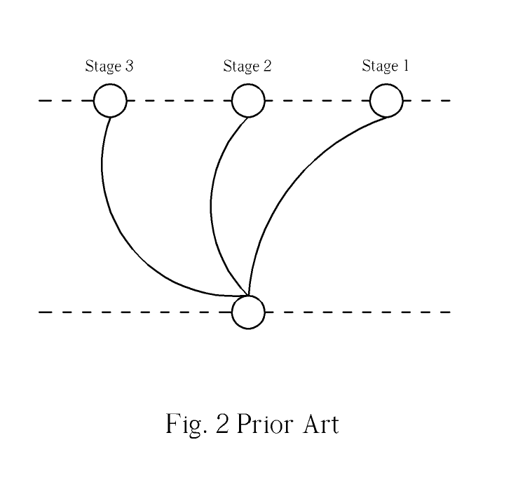

FIG. 3 is a diagram of a sliding-type mobile phone in another prior art.

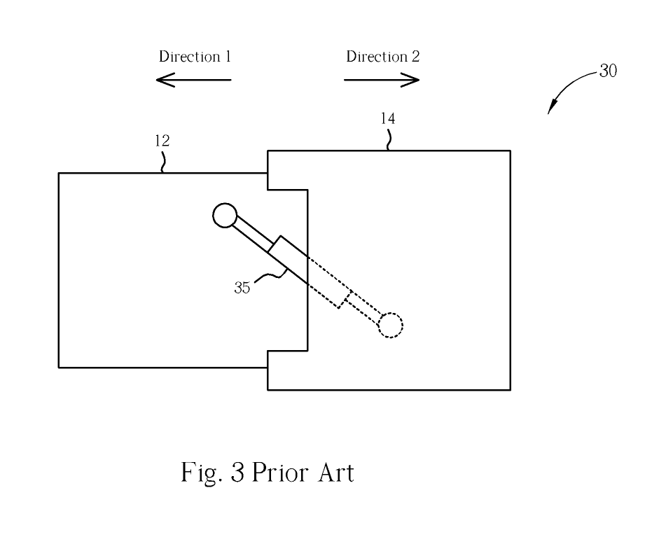

FIG. 4 is a diagram illustrating each stage of a spring while opening/closing the sliding-type mobile phone in FIG. 3.

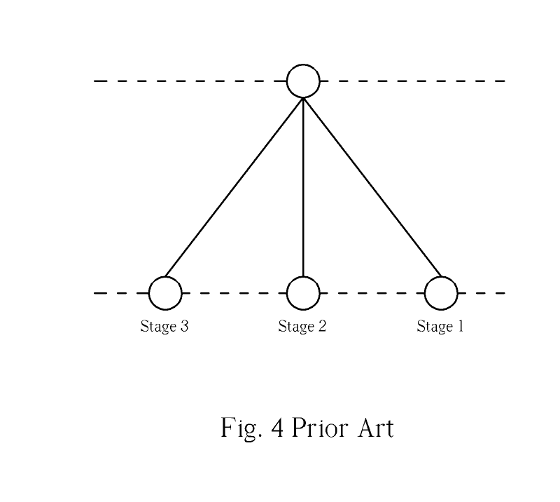

FIG. 5 is a diagram of an electronic device of the present invention.

FIG. 6 is an internal diagram of the electronic device while closing the electronic device completely of the present invention.

FIG. 7 is an internal diagram of the electronic device while opening the electronic device completely of the present invention.

FIG. 8 is an enlargement diagram of a gear module of the present invention.

FIG. 9 is an enlargement diagram of the gear module while the electronic device is opening of the present invention.

FIG. 10 is an enlargement diagram of the gear module while the electronic device is closing of the present invention.

### DETAILED DESCRIPTION

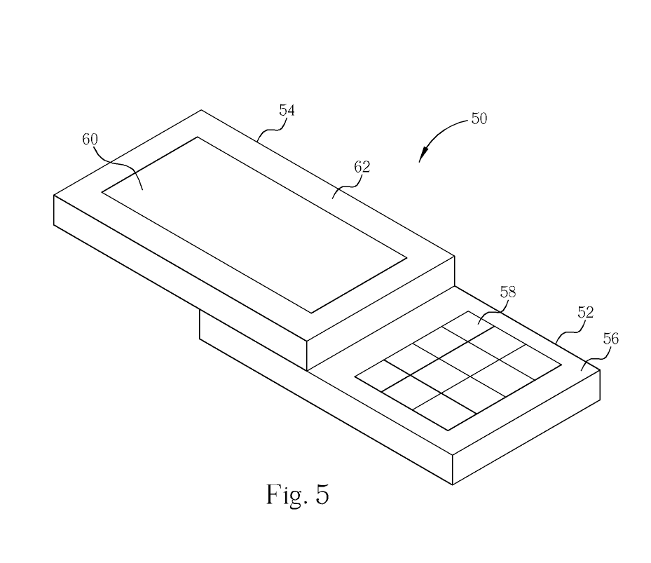

Please refer to FIG. 5. FIG. 5 is a diagram of an electronic device 50 of the present invention. The electronic device 50 can be a mobile phone, a personal digital assistant (PDA), and so on. The electronic device 50 includes a first module 52 and a second module 54. The second module 54 is connected to the top side of the first module 52 in a slidable manner so that a user can close or open the electronic device 50 by pushing the second module 54 towards or away from the first module 52. The first module 52 can include a processing unit (not shown in FIG. 5) installed inside a first housing 56 of the first module 52 for controlling operations of the electronic device 50, and a plurality of keys 58 installed on the first housing 56 of the first module 52 for inputting control signals to the processing unit. The user can also make a phone call by dialing a telephone number using the keys 58. The second module 54 includes a display panel 60 installed on a second housing 62 of the second module 54 for displaying images having been processed by the electronic device 50.

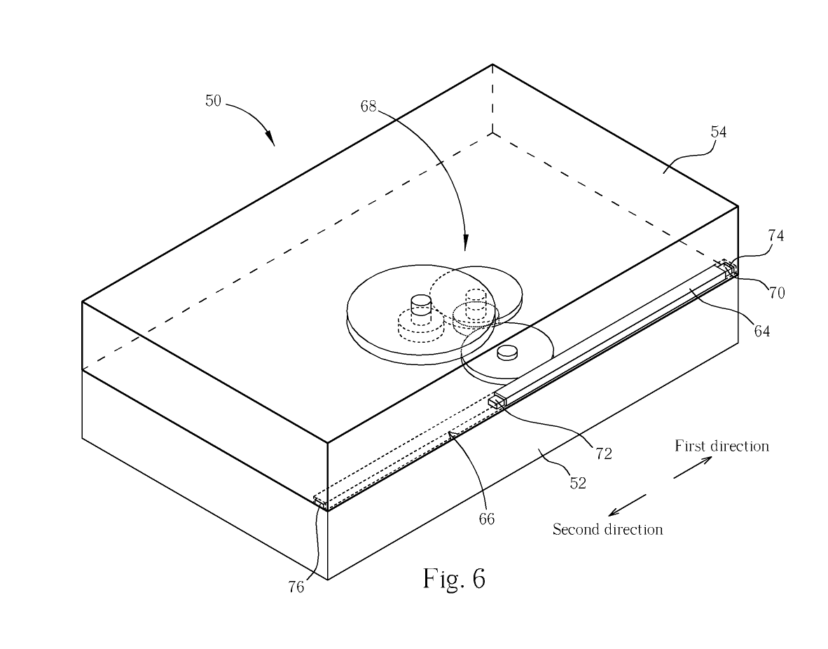

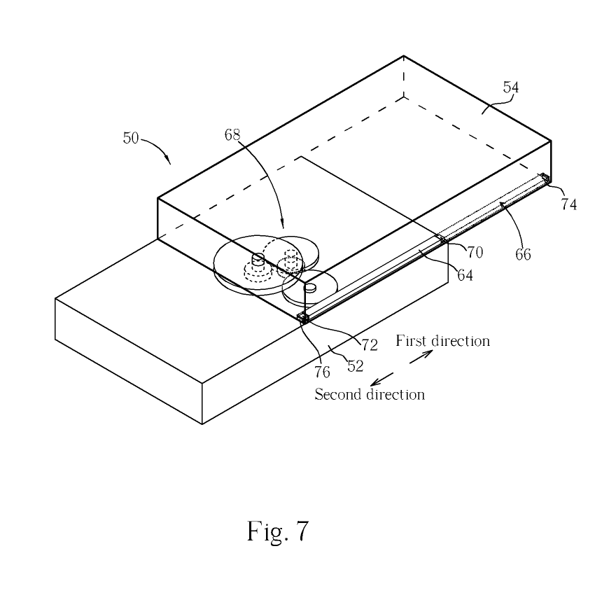

Please refer to FIG. 6 and FIG. 7. FIG. 6 is an internal diagram of the electronic device 50 while the electronic device 50 is closed completely of the present invention. FIG. 7 is an internal diagram of the electronic device 50 while the electronic device 50 is opened completely of the present invention. The first module 52 on the bottom of the electronic device 50 includes a rack 64. A slot 66 is disposed on the second module 54 on the top of the electronic device 50 for containing the rack 64. The second module 54 includes a gear module 68 engaged with the rack 64 in a slidable manner relative to the rack 64 so as to drive the second module 54 to slide relative to the first module 52. The first module 52 further includes a first fixing component 70 disposed on an end of the rack 64, and a second fixing component 72 disposed on the other end of the rack 64. The first fixing component 70 and the second fixing component 72 can be magnetic components, such as magnets. The first fixing component 70 and the second fixing component 72 can be other fixing means, such as protruding structures, hooks, and so on. The second module 54 further includes a first metal component 74 installed on an end of the slot 66, and a second metal component 76 installed on the other end of the slot 66. As shown in FIG. 6, when the first module 52 and the second module 54 are located in a relative position that the electronic device 50 is closed completely, the first fixing component 70 attracts the first metal component 74 so as to fix the combination of the first module 52 and the second module 54. On the other hand, as shown in FIG. 7, when the first module 52 and the second module 54 are located in a relative position that the electronic device 50 is open completely, the second fixing component 72 attracts the second metal component 76 so as to fix the combination of the first module 52 and the second module 54.

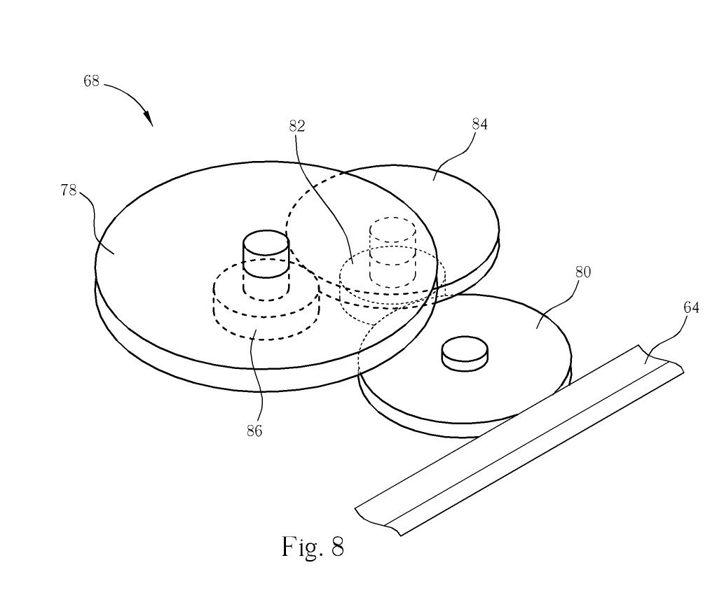

Please refer to FIG. 8. FIG. 8 is an enlargement diagram of the gear module 68 of the present invention. The gear module 68 includes a flywheel 78, a first gear 80 engaged with the rack 64, a second gear 82 engaged with the first gear 50, a third gear 84 being coaxial with the second gear 82, and a fourth gear 86 engaged with the third gear 84 and being coaxial with the flywheel 78. The rotational speed of the gear module 68 is magnified by adjusting the gear ratio. The flywheel can store kinetic energy so as to drive the second module 54 to slide relative to the first module 52. As shown in FIG. 6, when the first module 52 and the second module 54 are located in the relative position that the electronic device 50 is closed completely, the first fixing component 70 attracts the first metal component 74 so as to fix the combination of the first module 52 and the second module 54. If the force applied to the second module 54 to slide relative to the first module 52 in a first direction is greater then the attractive force of the first fixing component 70 and the first metal component 74, the first gear 80 engaged with the rack 64 will rotate to drive the second gear 82. The number of teeth of the first gear 80 is greater than the number of teeth of the second gear 82, so the rotational speed of the second gear 82 is greater than the rotational speed of the first gear 80. The number of teeth and the rotational speed are in an inverse proportion. The third gear 84 being coaxial with the second gear 82 can be driven by the second gear 82. The rotational speed of the third gear 84 is equal to the rotational speed of the second gear 82. The third gear 84 engaged with the fourth gear 86 drives the fourth gear 86. The number of teeth of the third gear 84 is greater than the number of teeth of the fourth gear 86, so the rotational speed of the fourth gear 86 is greater than the rotational speed of the third gear 84. The rotational speed is magnified twice when transferring from the first gear 80 to the fourth gear 86. The flywheel 78 being coaxial with the fourth gear 86 can be driven by the fourth gear 86. The kinetic energy of the gear module 68 increases due to the weight of the flywheel 78. For example, if the ratio of the number of teeth of the first gear 80, the second gear 82, the third gear 84, and the fourth gear 86 is 3:1:3:1 and the first gear 80 rotates at a speed of V, the second gear 82 rotates at a speed of 3V, the third gear 84 rotates at a speed of 3V, and the fourth gear 86 rotates at a speed of 9V. The rotational speed is magnified nine times.

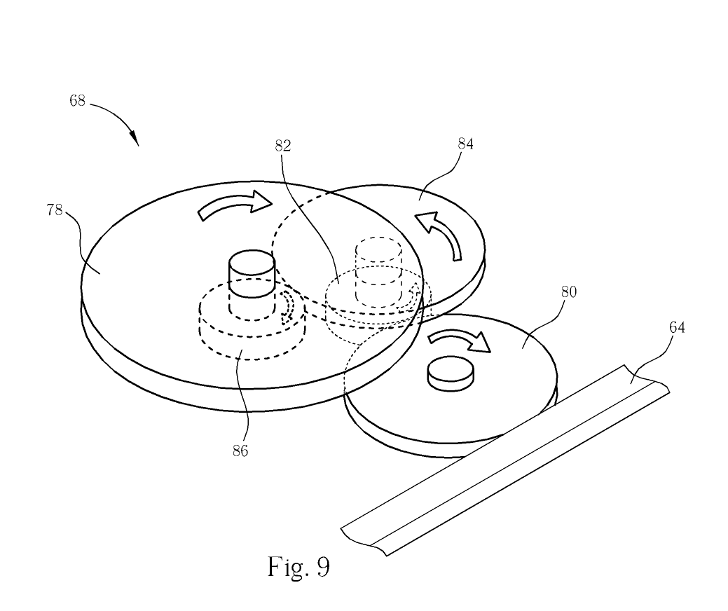

Please refer to FIG. 9. FIG. 9 is an enlargement diagram of the gear module 68 while the electronic device 50 is opening of the present invention. When the user stops pushing the second module 54 in the middle of the stoke relative to the first module 52 to open the electronic device 50, the gear module 68 continues rotating due to moment of inertia of the flywheel 78 related with the weight and rotational speed. The gear 68 is installed on the sliding component, the second module 54, and the first gear 80 is engaged with the rack 64 of the fixing component, the first module 52. The second module 54 will continue sliding along the rack 64. The attractive force of the second fixing component 72 and the second metal component 76 is increasing so as to provide kinetic energy of the second module 54 sliding along the rack 64. When the second module 54 slides to a position shown in FIG. 7 that the electronic device 50 is open completely, the second fixing component 72 attracts the second metal component 76 so as to fix the combination of the first module 52 and the second module 54.

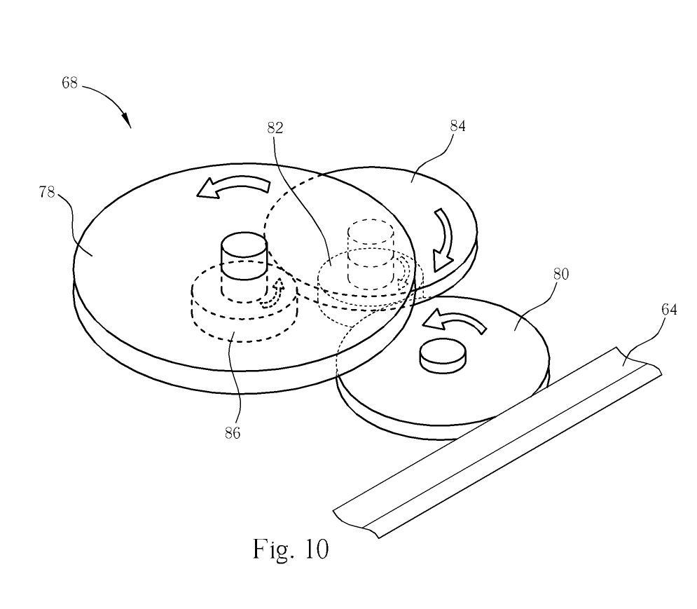

On the other hand, when the first module 52 and the second module 54 are located in the relative position shown in FIG. 7 that the electronic device 50 is open completely, the second fixing component 72 attracts the second metal component 76 so as to fix the combination of the first module 52 and the second module 54. If the force applied to the second module 54 to slide relative to the first module 52 in a second direction is greater then the attractive force of the second fixing component 72 and the second metal component 76, the first gear 80 engaged with the rack 64 will rotate to drive the gear module 68. The rotational direction of the gears of the gear module 68 is opposite to that mentioned above. Please refer to FIG. 10. FIG. 10 is an enlargement diagram of the gear module 68 while the electronic device 50 is closing of the present invention. When the user stops pushing the second module 54 in the middle of the stoke relative to the first module 52 to close the electronic device 50, the gear module 68 continues rotating due to moment of inertia of the flywheel 78 related with the weight and rotational speed. The gear 68 is installed on the sliding component, the second module 54, and the first gear 80 is engaged with the rack 64 of the fixing component, the first module 52. The second module 54 will continue sliding along the rack 64. The attractive force of the first fixing component 70 and the first metal component 74 is increasing so as to provide kinetic energy of the second module 54 sliding along the rack 64. When the second module 54 slides to a position shown in FIG. 6 that the electronic device 50 is closed completely, the first fixing component 70 attracts the first metal component 74 so as to fix the combination of the first module 52 and the second module 54. Furthermore, the rack 64, the first fixing component 70, and the second fixing component 72 can be installed on the second module 54, and the slot 66, the gear module 68, the first metal component 74, and the second metal component 76 can be disposed on the first module of another embodiment. The relative motion of the first module 52 and the second module 54 is the same as that mentioned above. The detailed description is omitted.

In conclusion, the present invention utilizes a simple gear module to achieve a semi-automatic opening and closing design of a slide construction. The gears can be made with an injection molding method so as to reduce cost. The size of the gears can depend on the size of the electronic device for design customization. The magnetic force of the magnets (the first fixing component and the second fixing component) can be adjusted so as to adjust an initial driving force of the sliding component. Furthermore, the sliding speed of the sliding component can be adjusted by modifying the gear ratio of the gear module or the weight of the flywheel.

In contrast to the prior art, the semi-automatic opening and closing mechanism of the present invention allows the electronic device opening or closing automatically when the user pushes the sliding component at a certain stroke. There is no need to continue pushing the sliding component to the top end to open the electronic device or pushing the sliding component to the bottom end to close the electronic device. It is convenient for the user to operate the electronic device, such as a mobile phone. The simple gears can be made with an injection molding method so as to reduce cost. The size of the gears can depend on the size of the electronic device for design customization. The magnetic force of the magnets can be adjusted so as to adjust an initial driving force of the sliding component. Furthermore, the sliding speed of the sliding component can be adjusted by modifying the gear ratio of the gear module or the weight of the flywheel. The present invention provides more design flexibility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a first module comprising a rack; and
a second module, a slot being positioned on the second module for containing the rack, the second module comprising a gear module engaged with the rack in a slidable manner relative to the rack so as to drive the second module to slide relative to the first module.

2. The electronic device of claim 1 wherein the gear module comprises a flywheel.

3. The electronic device of claim 2 wherein the gear module further comprises:
a first gear engaged with the rack;
a second gear engaged with the first gear;
a third gear being coaxial with the second gear; and
a fourth gear engaged with the third gear and being coaxial with the flywheel.

4. The electronic device of claim 1 wherein the first module comprises:
a first fixing component disposed on an end of the rack for fixing the first module and the second module when the first module and the second module are located in a first relative position; and
a second fixing component disposed on the other end of the rack for fixing the first module and the second module when the first module and the second module are located in a second relative position.

5. The electronic device of claim 4 wherein the first fixing component and the second fixing component are magnetic components.

6. The electronic device of claim 5 wherein the first fixing component and the second fixing component are magnets.

7. The electronic device of claim 5 wherein the second module further comprises:
a first metal component installed on an end of the slot; and
a second metal component installed on the other end of the slot.

8. The electronic device of claim 1 wherein the first module further comprises:
a processing unit for controlling operations of the electronic device; and
a plurality of keys for inputting control signals to the processing unit.

9. The electronic device of claim 1 wherein the second module further comprises a display panel for displaying images.

10. The electronic device of claim 1 being a mobile phone.

11. The electronic device of claim 1 being a personal digital assistant (PDA).
